(19) United States
(12) Patent Application Publication
(10) Pub. No.: US 2017/0103252 A1
(43) Pub. Date: Apr. 13, 2017

(54) FINGERPRINT RECOGNITION USING A LIQUID CRYSTAL DISPLAY INCLUDING FINGERPRINT RECOGNITION SENSORS

(71) Applicant: Xiaomi Inc., Beijing (CN)

(72) Inventors: Guosheng LI, Beijing (CN); Zhongsheng JIANG, Beijing (CN); Shanrong LIU, Beijing (CN)

(73) Assignee: Xiaomi Inc., Beijing (CN)

(21) Appl. No.: 15/060,023

(22) Filed: Mar. 3, 2016

(30) Foreign Application Priority Data
Oct. 9, 2015 (CN) 201510649735.1

(51) Int. Cl. G06K 9/00

(52) U.S. Cl. CPC G06K 9/00087; G06K 9/0002

(57) ABSTRACT

This disclosure relates to a method, apparatus, and non-transitory computer-readable storage medium for fingerprint recognition. Aspects of the disclosure provide a method for fingerprint recognition. The method includes receiving a fingerprint recognition command from a user, determining a region including positions of respective light sensors covered by at least one finger, selecting a set of fingerprint recognition sensors from a plurality of fingerprint recognition sensors based on the region, and acquiring, via the set of fingerprint recognition sensors, fingerprint data from the at least one finger.

### CROSS-REFERENCE TO RELATED APPLICATIONS

This application is based on and claims the priority of the Chinese patent application No. 201510649735.1 filed on Oct. 9, 2015, which is incorporated herein by reference in its entirety.

### TECHNICAL FIELD

The present disclosure relates to the field of fingerprint recognition, and more particularly, to fingerprint recognition using a liquid crystal display including fingerprint recognition sensors.

### BACKGROUND

Fingerprint recognition sensors may be used to authenticate a user of an electronic device. Once the user is authenticated, the user is allowed to operate the electronic device, thus preventing the operation of the electronic device by a stranger, and ensuring safety of the electronic device.

### SUMMARY

This Summary is provided to introduce a selection of aspects of the present disclosure in a simplified form that are further described below in the Detailed Description. This Summary is not intended to identify key features or essential features of the claimed subject matter, nor is it intended to be used to limit the scope of the claimed subject matter.

Aspects of the disclosure provide a method for fingerprint recognition. The method includes receiving a fingerprint recognition command from a user, determining a region including positions of respective light sensors covered by at least one finger, selecting a set of fingerprint recognition sensors from a plurality of fingerprint recognition sensors based on the region, and acquiring, via the set of fingerprint recognition sensors, fingerprint data from the at least one finger.

When determining the region, the method includes measuring a plurality of brightness values via a plurality of light sensors, determining a set of brightness values from the plurality of brightness values that are less than a preset threshold brightness value, and determining a first region including a set of light sensors from the plurality of light sensors that measured the set of brightness values.

The method also includes determining whether the set of light sensors is covered by the at least one finger. The set of fingerprint recognition sensors is selected based on the first region.

The plurality of fingerprint recognition sensors are distributed in an array on the liquid crystal display screen. The array includes a plurality of columns and a plurality of rows. When selecting the set of fingerprint recognition sensors, the method includes determining a set of columns from the plurality of columns that are covered by the at least one finger and a set of rows from the plurality of rows that are covered by the at least one finger, generating a rectangular recognition region by taking a number of columns in the set of columns as length and a number of rows in the set of rows as width, and determining the set of fingerprint recognition sensors based on which of the plurality of fingerprint recognition sensors are distributed in the rectangular recognition region.

When acquiring the fingerprint data, the method includes connecting the set of fingerprint recognition sensors with corresponding data lines, and receiving, via the data lines, the fingerprint data collected by the set of fingerprint recognition sensors.

Each of the plurality of the fingerprint recognition sensors is electrically connected with a corresponding one of a plurality of enabling lines. When connecting the set of fingerprint recognition sensors with the corresponding data lines, the method includes initializing the plurality of fingerprint recognition sensors, and controlling corresponding ones of the enabling lines to connect the set of fingerprint recognition sensors with the corresponding data lines.

Aspects of the disclosure also provide an apparatus for fingerprint recognition. The apparatus includes a liquid crystal displays screen including a plurality of fingerprint recognition sensors and a plurality of light sensors, a processor, and a memory for storing instructions executable by the processor. The processor is configured to receive a fingerprint recognition command from a user, determine a region including positions of respective light sensors covered by at least one finger, select a set of fingerprint recognition sensors from the plurality of fingerprint recognition sensors based on the region, and acquire, via the set of fingerprint recognition sensors, fingerprint data from the at least one finger.

The processor is also configured to measure a plurality of brightness values via the plurality of light sensors, determine a set of brightness values from the plurality of brightness values that are less than a preset threshold brightness value, and determine a first region including a set of light sensors from the plurality of light sensors that measured the set of brightness values.

The processor is also configured to determine whether the set of light sensors is covered by the at least one finger. The set of fingerprint recognition sensors is selected based on the first region.

The plurality of fingerprint recognition sensors are distributed in an array on the liquid crystal display screen. The array includes a plurality of columns and a plurality of rows. When selecting the set of fingerprint recognition sensors, the processor is also configured to determine a set of columns from the plurality of columns that are covered by the at least one finger and a set of rows from the plurality of rows that are covered by the at least one finger, generate a rectangular recognition region by taking a number of columns in the set of columns as length and a number of rows in the set of rows as width, and determine the set of fingerprint recognition sensors based on which of the plurality of fingerprint recognition sensors are distributed in the rectangular recognition region.

When acquiring the fingerprint data, the processor is also configured to connect the set of fingerprint recognition sensors with corresponding data lines, and receive, via the data lines, the fingerprint data collected by the set of fingerprint recognition sensors.

Each of the plurality of the fingerprint recognition sensors is electrically connected with a corresponding one of a plurality of enabling lines. When connecting the set of fingerprint recognition sensors with the corresponding data lines, the processor is also configured to initialize the plurality of fingerprint recognition sensors, and control corresponding ones of the enabling lines to connect the set of fingerprint recognition sensors with the corresponding data lines.

Aspects of the disclosure also provide a non-transitory computer-readable storage medium having stored therein instructions that, when executed by a processor, cause the processor to perform a method of fingerprint recognition. The method includes receiving a fingerprint recognition command from a user, determining a region including positions of respective light sensors covered by at least one finger, selecting a set of fingerprint recognition sensors from a plurality of fingerprint recognition sensors based on the region, and acquiring, via the set of fingerprint recognition sensors, fingerprint data from the at least one finger.

The technical solutions of this disclosure have following beneficial effects: a fingerprint recognition command triggered by fingers of a user is acquired; a shielding region consisting of positions of respective light sensors shielded by the fingers is determined after the fingerprint recognition command is received; part of fingerprint recognition sensors are selected according to the shielding region; and the selected part of fingerprint recognition sensors are controlled to recognize fingerprints of the fingers, part of fingerprint recognition sensors can be controlled to recognize fingerprints, thus solving the problem of resource waste caused by the fact that all fingerprint recognition sensors on the whole liquid crystal display screen are controlled to recognize fingerprints, and achieving a resource saving effect.

It should be understood that both the foregoing general description and the following detailed description are only exemplary and explanatory and are not restrictive of the present disclosure.

### BRIEF DESCRIPTION OF THE DRAWINGS

The accompanying drawings, which are incorporated in and constitute a part of this specification, illustrate aspects consistent with the present disclosure and, together with the description, serve to explain the principles of the present disclosure.

FIG. 1 is a flow chart showing a fingerprint recognition method according to an exemplary aspect of the present disclosure.

FIG. 2A is a flow chart showing a fingerprint recognition method according to another exemplary aspect of the present disclosure.

FIG. 2B is a schematic diagram showing a shielding region according to another exemplary aspect of the present disclosure.

FIG. 2C is a schematic diagram showing a recognition region according to another exemplary aspect of the present disclosure.

FIG. 2D is a flow chart showing controlling part of fingerprint recognition sensors to recognize fingerprints according to another exemplary aspect of the present disclosure.

FIG. 2E is a first schematic diagram showing fingerprint recognition sensors according to another exemplary aspect of the present disclosure.

FIG. 2F is a second schematic diagram showing fingerprint recognition sensors according to another exemplary aspect of the present disclosure.

FIG. 3 is a block diagram showing a fingerprint recognition apparatus according to an exemplary aspect of the present disclosure.

FIG. 4 is a block diagram showing a fingerprint recognition apparatus according to an exemplary aspect of the present disclosure.

FIG. 5 is a block diagram showing an apparatus for fingerprint recognition according to an exemplary aspect of the present disclosure.

### DETAILED DESCRIPTION

Reference will now be made in detail to exemplary aspects of the present disclosure, examples of which are illustrated in the accompanying drawings. The following description refers to the accompanying drawings in which the same numbers in different drawings represent the same or similar elements unless otherwise represented. The implementations set forth in the following description of exemplary aspects do not represent all implementations consistent with the present disclosure. Instead, they are merely examples of apparatuses and methods consistent with aspects related to the present disclosure as recited in the appended claims.

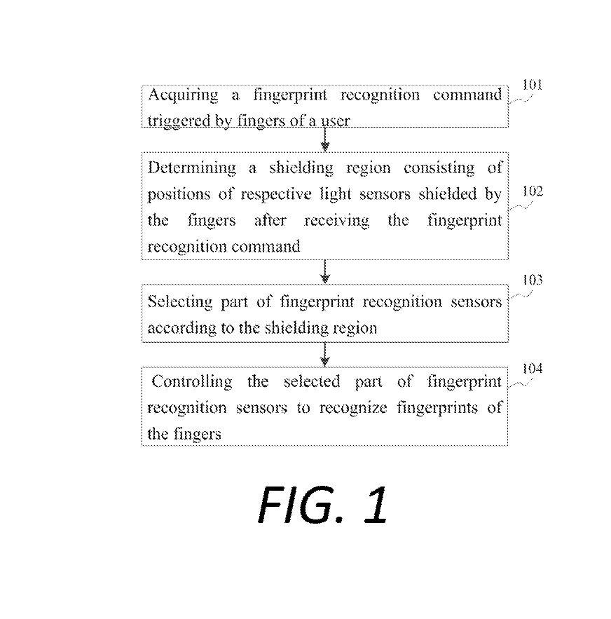

FIG. 1 is a flow chart showing a fingerprint recognition method according to an exemplary aspect of the present disclosure, the fingerprint recognition method is used in an electronic device comprising a liquid crystal display screen on which fingerprint recognition sensors and light sensors are distributed, and as shown in FIG. 1, the fingerprint recognition method comprises following steps:

in step 101, acquiring a fingerprint recognition command triggered by fingers of a user;

in step 102, determining a shielding region consisting of positions of respective light sensors shielded by the fingers after receiving the fingerprint recognition command;

in step 103, selecting part of fingerprint recognition sensors according to the shielding region; and

in step 104, controlling the selected part of fingerprint recognition sensors to recognize fingerprints of the fingers.

To sum up, according to the fingerprint recognition method provided in the present disclosure, a fingerprint recognition command triggered by fingers of a user is acquired; a shielding region consisting of positions of respective light sensors shielded by the fingers is determined after the fingerprint recognition command is received; part of fingerprint recognition sensors are selected according to the shielding region; and the selected part of fingerprint recognition sensors are controlled to recognize fingerprints of the fingers, part of fingerprint recognition sensors may be controlled to recognize fingerprints, thus solving the problem of resource waste caused by the fact that all fingerprint recognition sensors on the whole liquid crystal display screen are controlled to recognize fingerprints, and achieving a resource saving effect.

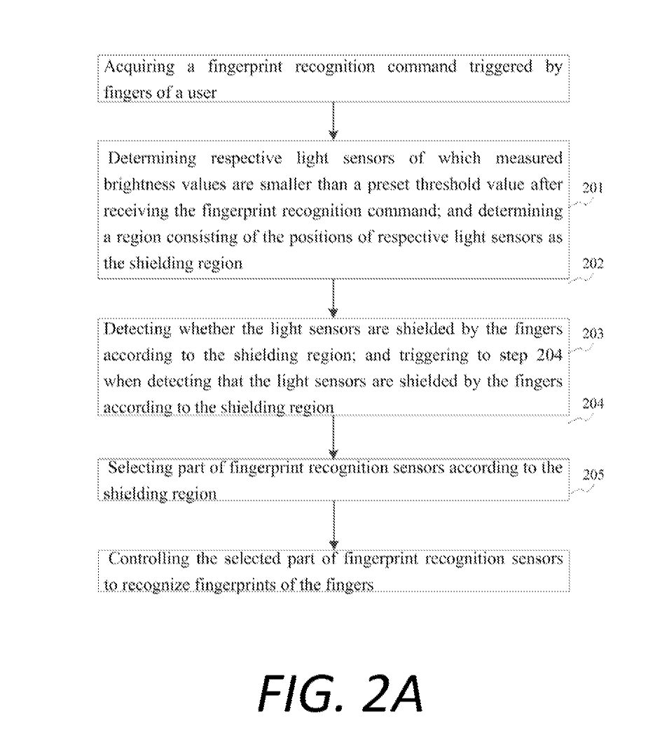

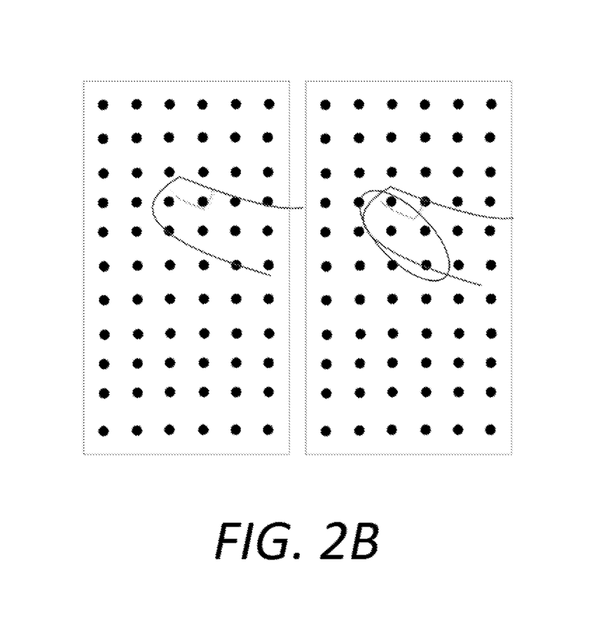

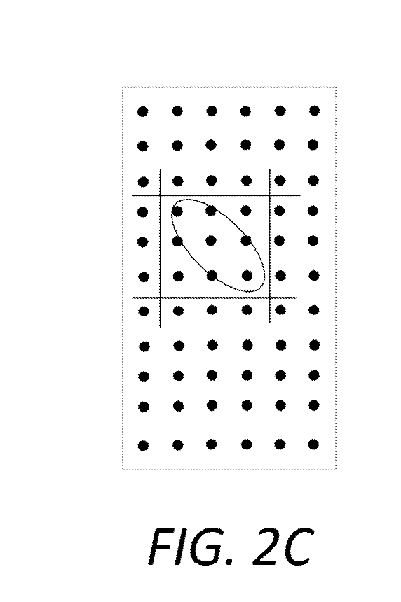

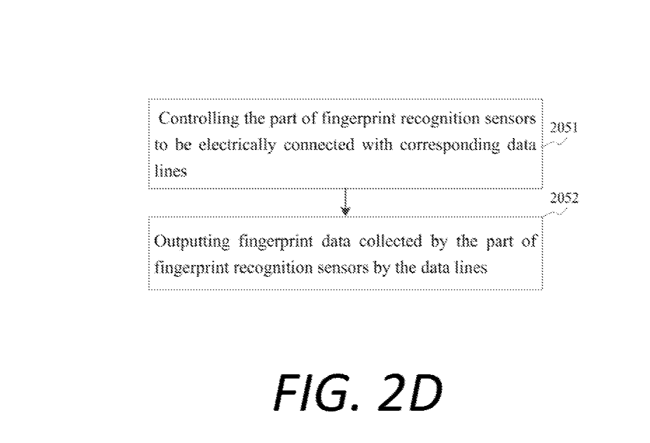

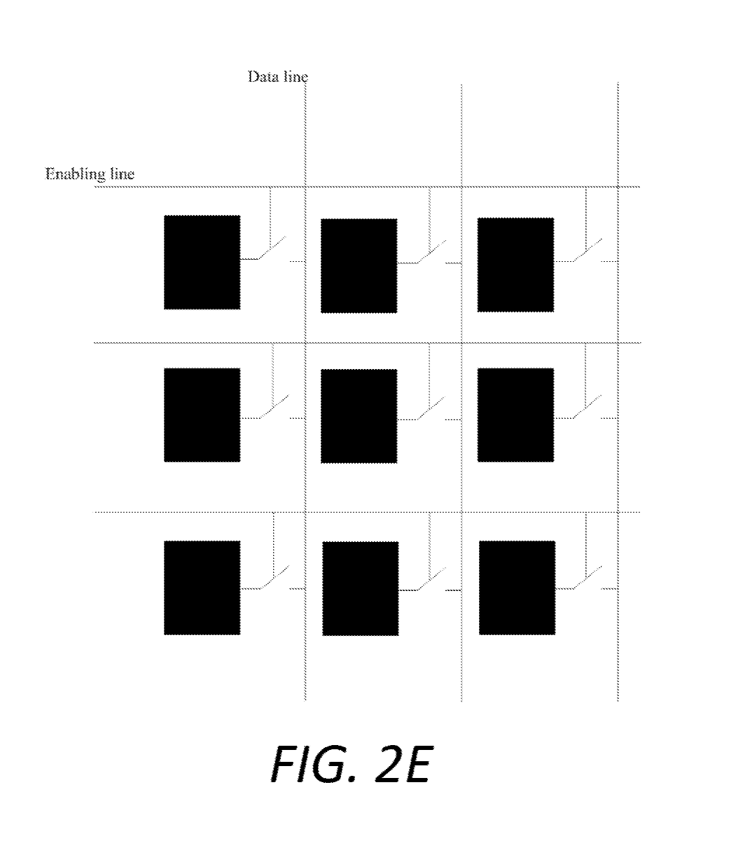

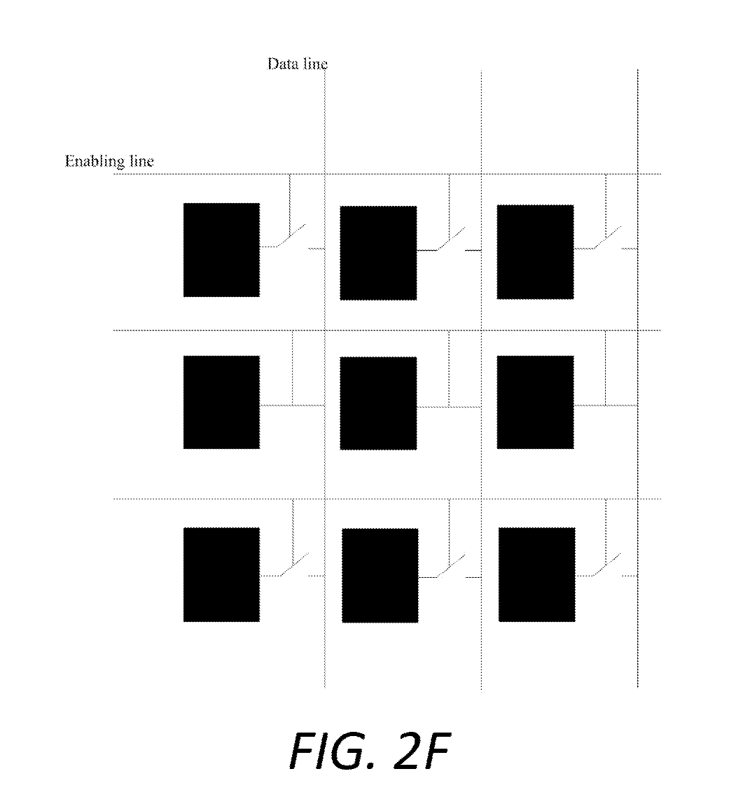

FIG. 2A is a flow chart showing a fingerprint recognition method according to another exemplary aspect of the present disclosure, the fingerprint recognition method is used in an electronic device comprising a liquid crystal display screen on which fingerprint recognition sensors and light sensors are distributed, and as shown in FIG. 2A, the fingerprint recognition method comprises following steps:

In step 201, acquiring a fingerprint recognition command triggered by fingers of a user.

The fingerprint recognition command is configured to instruct an electronic device to start a fingerprint recognition service to recognize fingerprints. The fingerprint recognition command may be generated by controlling an application program with fingers in a process of using the application program by a user, and then acquired by the electronic device; the fingerprint recognition command also can be acquired by the electronic device through other manners. The present aspect does not limit an acquiring manner of the fingerprint recognition command.

In step 202, determining respective light sensors of which measured brightness values are smaller than a preset threshold value after receiving the fingerprint recognition command; and determining a region consisting of the positions of respective light sensors as the shielding region.

After the fingerprint recognition command is received, the user needs to trigger a touch operation on a liquid crystal display screen with fingers to facilitate the electronic device to recognize fingerprints. When fingers of the user contact the liquid crystal display screen, the fingers will shield ambient light transmitted to the light sensors, at the moment, brightness values of the ambient light measured by the light sensors are smaller, therefore, the electronic device can determine whether the fingers contact the liquid crystal display screen according to brightness values measured by respective light sensors. During implementation, the electronic device can acquire the brightness values acquired by all light sensors, and compare respective brightness values with a preset threshold value, and when a certain brightness valve is smaller than the preset threshold value, it is indicated that the light sensor is shielded and the fingers contact the liquid crystal display screen.

In the present aspect, the electronic device can determine positions of respective light sensors of which the brightness values are smaller than the preset threshold value, and takes a region consisting of respective positions as a shielding region. Please refer to a schematic diagram of the shielding region as shown in FIG. 2B, wherein, black dots distributed on the liquid crystal display screen represent the light sensors, a left side view in FIG. 2B represents that the fingers of the user trigger a touch operation on the liquid crystal display screen, and a right side view in FIG. 2B represents an oval shielding region of the touch operation.

In step 203, detecting whether the light sensors are shielded by the fingers according to the shielding region; and proceeding to step 204 when detecting that the light sensors are shielded by the fingers according to the shielding region.

Since the touch operation may be triggered by the fingers of the user, or by other parts such as a palm of the user, the electronic device needs to exclude the touch operation triggered by the other parts, thus avoiding resource waste caused by starting of a fingerprint recognition service for fingerprint recognition.

During implementation, the electronic device can compute an area of the shielding region, and detects whether the area is smaller than a preset area threshold value, when the area is smaller than the preset area threshold value, it is determined that the touch operation is triggered by fingers; when the area is larger than the preset area threshold value, it is determined that the touch operation is not triggered by the fingers. Or, the electronic device can detect whether the shape of the shielding region is oval, when the shape is oval, it is determined that the touch operation is triggered by fingers; when the shape is not oval, it is determined that the touch operation is not triggered by the fingers Of course, the electronic device can detect whether the touch operation is triggered by the fingers by other manners, which is not limited in the present aspect;

In step 204, selecting part of fingerprint recognition sensors accord to the shielding region.

Since the contact region between the fingers and the liquid crystal display screen is the shielding region, and the electronic device needs to recognize fingerprints of the fingers, the electronic device can select part of fingerprint recognition sensors according to the shielding region to recognize the fingerprints, thus solving the problem of resource waste caused by the fact that all fingerprint recognition sensors on the whole liquid crystal display screen are controlled to recognize fingerprints, and achieving a resource saving effect,

Wherein, the present aspect provides two methods for selecting part of fingerprint recognition sensors according to a shielding region, which are respectively described hereinafter.

In the first determining method, determining respective fingerprint recognition sensors distributed in the shielding region.

Wherein, the electronic device can control respective fingerprint recognition sensors distributed in the shielding region to recognize the fingerprints. At the moment, the electronic device can acquire coordinates of respective fingerprint recognition sensors on a liquid crystal display screen, and then determine respective fingerprint recognition sensors distributed in the shielding region according to the coordinates.

In the second determining method, determining a column number and a row number covered by the shielding region when the fingerprint recognition sensors are in array distribution on the liquid crystal display screen, generating a rectangular recognition region by taking the column number as length and the row number as width, and determining respective fingerprint recognition sensors distributed in the recognition region.

The shape of the shielding region may be irregular, and the electronic device has larger calculated amount when determining the fingerprint recognition sensors distributed in the recognition region, therefore, the electronic device can determine recognition region containing the shielding region in a regular shape, and then acquire coordinates of respective fingerprint recognition sensors on the liquid crystal display screen, and determines respective fingerprint recognition sensors distributed in the shielding region according to the coordinates.

Wherein, when the fingerprint recognition sensors are in array distribution on the liquid crystal display screen, the recognition region may be a rectangular region, since the length and width of the rectangular region are fixed, the electronic device can determine respective fingerprint recognition sensors distributed in the recognition region very easily.

Please refer to a schematic diagram of a recognition region as shown in FIG. 2C, wherein, black dots distributed on the liquid crystal display screen represent fingerprint recognition sensors, the oval region is the shielding region, then the fingerprint recognition sensors distributed in the shielding region are second-third fingerprint recognition sensors in the fourth row, second-fourth fingerprint recognition sensors in the fifth row, and third-fourth fingerprint recognition sensors in the sixth row. The recognition region determined by the oval region is a rectangular region, and then the fingerprint recognition sensors distributed in the rectangular region are second-fourth fingerprint recognition sensors in the fourth-sixth rows.

In step 205, controlling the selected part of fingerprint recognition sensors to recognize fingerprints of the fingers

Please refer to a flow chart showing controlling part of fingerprint recognition sensors to recognize fingerprints of the fingers as shown in FIG. 2D, controlling the selected part of fingerprint recognition sensors to recognize fingerprints of the fingers comprises:

in step 2051, controlling the part of fingerprint recognition sensors to be electrically connected with corresponding data lines; and

in step 2052, outputting fingerprint data collected by the part of fingerprint recognition sensors by the data lines.

After the fingerprint recognition sensors are determined, the electronic device needs to start these fingerprint recognition sensors, so as to recognize fingerprints through these fingerprint recognition sensors, wherein, starting the fingerprint recognition sensors comprises initializing the fingerprint recognition sensors and controlling the fingerprint recognition sensors to be electrically connected with data lines by enabling ends.

During implementation, controlling the part of fingerprint recognition sensors to be electrically connected with corresponding data lines comprises: initializing all fingerprint recognition sensors, and controlling the part of fingerprint recognition sensors to be electrically connected with corresponding data lines by enabling lines, wherein each fingerprint recognition sensor is electrically connected with a corresponding enabling line.

Initializing all fingerprint recognition sensors comprises starting a fingerprint recognition service, controlling all fingerprint recognition sensors to be in an idle state and to wait for a scanning command, wherein the enabling end of each fingerprint recognition sensor is electrically connected with the corresponding enabling line, whether the fingerprint recognition sensors are electrically connected with the data lines is controlled by signals transmitted on the enabling lines, and the data lines are used for transmitting collected fingerprint data.

Please refer to a first schematic diagram of fingerprint recognition sensors as shown in FIG. 2E, wherein, the black rectangles are fingerprint recognition sensors, transverse lines are enabling lines, vertical lines are data lines, and each fingerprint recognition sensor is connected to a corresponding data line by one switch and is not connected with the data line.

Please refer to a second schematic diagram of fingerprint recognition sensors as shown in FIG. 2F, it is assumed that the electronic device needs to control the fingerprint recognition sensors in the second row to recognize fingerprints, then respective fingerprint recognition sensors in the second row can be controlled to be electrically connected with the data lines by signals transmitted on the enabling lines.

After the fingerprint recognition sensors are electrically connected with the data lines, the electronic device controls these fingerprint recognition sensors to scan by a scanning command to obtain fingerprint data, and transmits these data by the data lines for fingerprint recognition treatment, wherein, when the fingerprint recognition sensors are capacitance type fingerprint recognition sensors, the fingerprint data are capacitance values.

It needs to be indicated that the step of initializing the fingerprint recognition sensors can be executed at the earliest after step 201, thus causing the electronic device to directly recognize the fingerprints by the fingerprint recognition sensors in an idle state after determining the fingerprint recognition sensors, and improving the fingerprint recognition efficiency; or the step can be executed at latest after the electronic device determines the fingerprint recognition sensors to be subject to fingerprint recognition, thus saving the resource waste caused by too early starting of a fingerprint recognition service.

In conclusion, according to the fingeiprint recognition method provided in the present disclosure, a fingerprint recognition command triggered by fingers of a user is acquired; a shielding region consisting of positions of respective light sensors shielded by the fingers is determined after the fingerprint recognition command is received; part of fingerprint recognition sensors are selected according to the shielding region; and the selected part of fingerprint recognition sensors are controlled to recognize fingerprints of the fingers, part of fingerprint recognition sensors may be controlled to recognize fingerprints, thus solving the problem of resource waste caused by the fact that all fingerprint recognition sensors on the whole liquid crystal display screen are controlled to recognize fingerprints, and achieving a resource saving effect.

In addition, respective light sensors with measured brightness values being smaller than a preset threshold value are determined, a region consisting of the positions of respective light sensors is determined as a shielding region, contact between fingers and a liquid crystal display screen can be determined by the light sensors firstly, and then a fingerprint recognition service is started, thus avoiding the problem of resource waste caused by too early starting of the fingerprint recognition service, and achieving a resource saving effect.

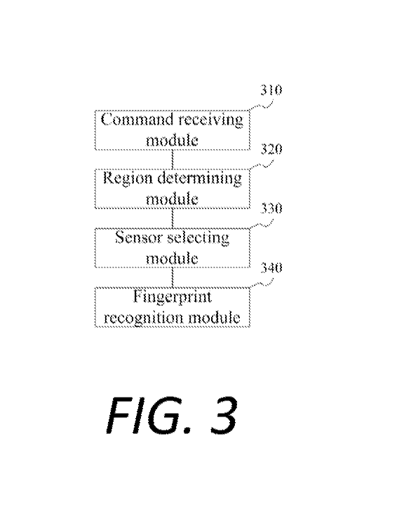

FIG. 3 is a block diagram showing a fingerprint recognition apparatus according to an exemplary aspect of the present disclosure, the fingerprint recognition apparatus is used in an electronic device comprising a liquid crystal display screen on which fingerprint recognition sensors and light sensors are distributed, and as shown in FIG. 3, the apparatus comprises: a command receiving module 310, a region determining module 320, a sensor selecting module 330 and a fingerprint recognition module 340.

The command receiving module 310 is configured to acquire a fingerprint recognition command triggered by fingers of a user.

The region determining module 320 is configured to determine a shielding region consisting of positions of respective light sensors shielded by the fingers after the command receiving module 310 receives the fingerprint recognition command.

The sensor selecting module 330 is configured to select part of fingerprint recognition sensors according to the shielding region determined by the region determining module 320.

The fingerprint recognition module 340 is configured to control the part of fingerprint recognition sensors selected by the sensor selecting module 330 to recognize fingerprints of fingers.

In conclusion, according to the fingerprint recognition apparatus provided in the present disclosure, a fingerprint recognition command triggered by fingers of a user is acquired; a shielding region consisting of positions of respective light sensors shielded by the fingers is determined after the fingerprint recognition command is received: part of fingerprint recognition sensors are selected according to the shielding region; and the selected part of fingerprint recognition sensors are controlled to recognize fingerprints of fingers, part of fingerprint recognition sensors may be controlled to recognize fingerprints, thus solving the problem of resource waste caused by the fact that all fingerprint recognition sensors on the whole liquid crystal display screen are controlled to recognize fingerprints, and achieving a resource saving effect.

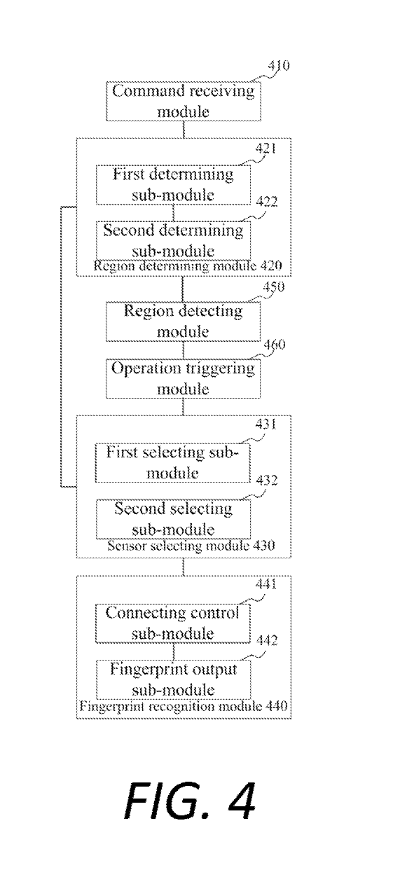

FIG. 4 is a block diagram showing a fingerprint recognition apparatus according to an exemplary aspect of the present disclosure, the fingerprint recognition apparatus is used in an electronic device comprising a liquid crystal display screen on which fingerprint recognition sensors and light sensors are distributed, and as shown in FIG. 4, the fingerprint recognition apparatus comprises: a command receiving module 410, a region determining module 420, a sensor selecting module 430 and a fingerprint recognition module 440.

The command receiving module 410 is configured to acquire a fingerprint recognition command triggered by fingers of a user.

The region determining module 420 is configured to determine a shielding region consisting of positions of respective light sensors shielded by the fingers after the command receiving module 410 receives the fingerprint recognition command.

The sensor selecting module 430 is configured to select part of fingerprint recognition sensors according to the shielding region determined by the region determining module 420.

The fingerprint recognition module 440 is configured to control the part of fingerprint recognition sensors selected by the sensor selecting module 430 to recognize fingerprints of fingers.

Optionally, the region determining module 420 includes: a first determining sub-module 421 and a second determining sub-module 422.

The first determining sub-module 421 is configured to determine respective light sensors of which measured brightness values are smaller than a preset threshold value after receiving the fingerprint recognition command.

The second determining sub-module 422 is configured to determine a region consisting of the positions of respective light sensors as the shielding region.

Optionally, the fingerprint recognition apparatus provided in the present aspect further comprises: a region detecting module 450 and an operation triggering module 460.

The region detecting module 450 is configured to detect whether the light sensors are shielded by the fingers according to the shielding region.

The operation triggering module 460 is configured to trigger to execute the step of controlling the selected part of fingerprint recognition sensors to recognize the fingerprint when the region detecting module 450 detects that the light sensors are shielded by the fingers according to the shielding region.

Optionally, the sensor selecting module 430 includes:

a first selecting sub-module 431 configured to determine respective fingerprint recognition sensors distributed in the shielding region; or,

a second selecting sub-module 432 configured to determine a column number and a row number covered by the shielding region when the fingerprint recognition sensors are in array distribution on the liquid crystal display screen, generate a rectangular recognition region by taking the column number as length and the row number as width, and determine respective fingerprint recognition sensors distributed in the recognition region.

Optionally, the fingerprint recognition module 440 includes: a connecting control sub-module 441 and a fingerprint output sub-module 442.

The connecting control sub-module 411 is configured to control the part of fingerprint recognition sensors to be electrically connected with corresponding data lines.

The fingerprint output sub-module 442 is configured to output fingerprint data collected by the part of fingerprint recognition sensors by the data lines.

Optionally, the connecting control sub-module 441 is further configured to:

initialize all fingerprint recognition sensors, and control the part of fingerprint recognition sensors to be electrically connected with corresponding data lines by enabling lines, wherein each fingerprint recognition sensor is electrically connected with a corresponding enabling line.

In conclusion, according to the fingerprint recognition apparatus provided in the present disclosure, a fingerprint recognition command triggered by fingers of a user is acquired; a shielding region consisting of positions of respective light sensors shielded by the fingers is determined after the fingerprint recognition command is received; part of fingerprint recognition sensors are selected according to the shielding region; and the selected part of fingerprint recognition sensors are controlled to recognize fingerprints of the fingers, part of fingerprint recognition sensors may be controlled to recognize fingerprints, thus solving the problem of resource waste caused by the fact that all fingerprint recognition sensors on the whole liquid crystal display screen are controlled to recognize fingerprints, and achieving a resource saving effect.

In addition, respective light sensors with measured brightness values being smaller than a preset threshold value are determined, a region consisting of the positions of respective light sensors is determined as a shielding region, contact between fingers and a liquid crystal display screen can be determined by the light sensors firstly, and then a fingerprint recognition service is started, thus avoiding the problem of resource waste caused by too early starting of the fingerprint recognition service, and achieving a resource saving effect.

With respect to the apparatus in above aspects, specific operation executing manners of respective modules have been described in detail in the aspects related to the method, and are not repeated in detail herein.

Au exemplary aspect of this disclosure provides a fingerprint recognition apparatus, capable of realizing the fingerprint recognition method provided in the present disclosure, the fingerprint recognition apparatus is used in an electronic device and comprises a liquid crystal displays screen on which fingerprint recognition sensors and light sensors are distributed, a processor, and a memory for storing a command executable by the processor,

wherein, the processor is configured to:

acquire a fingerprint recognition command triggered by fingers of a user;

determine a shielding region consisting of positions of respective light sensors shielded by the fingers after receiving the fingerprint recognition command;

select part of fingerprint recognition sensors according to the shielding region; and

control the selected part of fingeiprint recognition sensors to recognize fingerprints of the fingers.

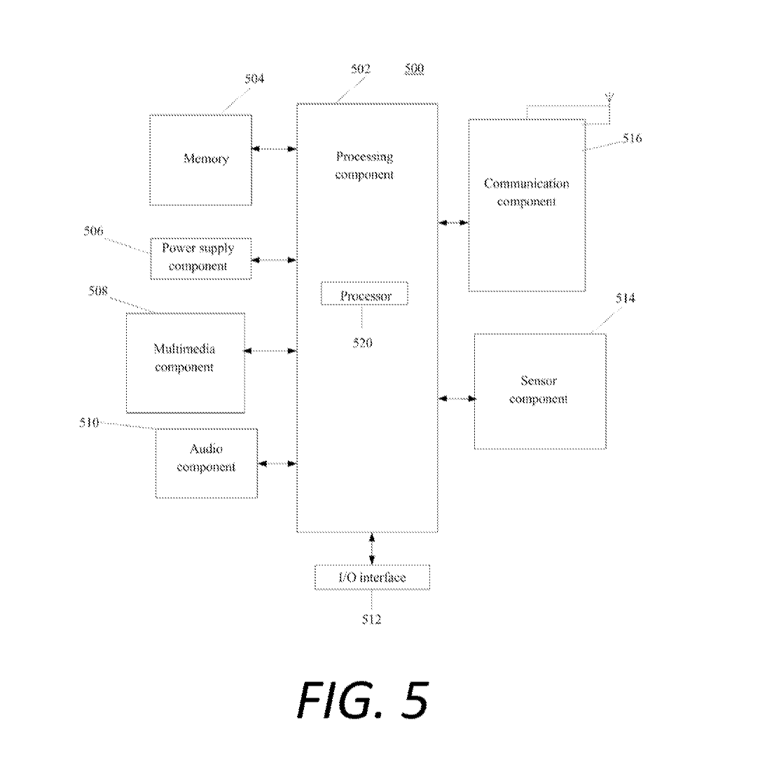

FIG. 5 is a block diagram showing an apparatus 500 for fingerprint recognition according to an exemplary aspect of the present disclosure. For example, the apparatus 500 may be a mobile phone, a computer, a digital broadcast terminal, a messaging device, a game console, a panel device, a medical device, a fitness equipment, a personal digital assistant or the like.

With reference to FIG. 5, the apparatus 500 may comprise one or more of following components: a processing component 502, a memory 504, a power supply component 506, a multimedia component 508, an audio component 510, an input/output (I/O) interface 512, a sensor component 514, and a communication component 516.

The processing component 502 typically controls overall operations of the apparatus 500, such as the operations associated with display, telephone calls, data communications, camera operations, and recording operations. The processing component 502 may include one or more processors 518 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the apparatus 500. Examples of such data include instructions for any applications or methods operated on the apparatus 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 506 provides power to various components of the apparatus 500. The power supply component 506 may include a power supply management system, one or more power sources, and any other components associated with the generation, management, and distribution of power in the apparatus 500.

The multimedia component 508 includes a screen providing an output interface between the apparatus 500 and the user. In some aspects, the screen may include a liquid crystal display (LCD) and a touch panel (TP). If the screen includes the touch panel, the screen may be implemented as a liquid crystal display screen to receive input signals from the user. The touch panel includes one or more touch sensors to sense touches, swipes, and gestures on the touch panel. The touch sensors may not only sense a boundary of a touch or swipe action, but also detect a period of time and a pressure associated with the touch or swipe action. In some aspects, the multimedia component 508 includes a front camera and/or a rear camera. The front camera and/or the rear camera may receive external multimedia data while the apparatus 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone (MIC) configured to receive an external audio signal when the apparatus 500 is in an operation mode, such as a call mode a recording mode, and a voice recognition mode. The received audio signal may be further stored in the memory 504 or transmitted via the communication component 516. In some aspects, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the apparatus 500. For instance, the sensor component 514 may detect an opened/closed status of the apparatus 500, relative positioning of components, e.g., the display and the keypad, of the apparatus 500, a change in position of the apparatus 500 or a component of the apparatus 500, a presence or absence of user contact with the apparatus 500, an orientation or an acceleration deceleration of the apparatus 500, and a change in temperature of the apparatus 500. The sensor component 514 may include a proximity sensor configured to detect the presence of nearby objects without any physical contact. The sensor component 514 may also include a light sensor, such as a CMOS or CCD image sensor, for use in imaging applications. The sensor component 514 may also include a fingerprint recognition sensor, configured to recognize fingerprints. In some aspects, the sensor component 514 may also include an accelerometer sensor, a gyroscope sensor, a magnetic sensor, a pressure sensor, or a temperature sensor.

The communication component 516 is configured to facilitate communication, wired or wirelessly, between the apparatus 500 and other devices. The apparatus 500 can access a wireless network based on a communication standard, such as WiFi, 2G or 3G, or a combination thereof. In one exemplary aspect of the present disclosure, the communication component 516 receives a broadcast signal Or broadcast associated information from an external broadcast management system via a broadcast channel. In one exemplary aspect of the present disclosure, the communication component 516 further includes a near field communication (NFC) module to facilitate short-range communications. For example, the NTC module may be implemented based on a radio frequency identification (RFID) technology, an infrared data association (IrDA) technology, an ultra-wideband (UWB) technology, a Bluetooth (BT) technology, and other technologies.

In exemplary aspects of the present disclosure, the apparatus 500 may be implemented with one or more application specific integrated circuits (ASICs), digital signal processors (DSPs), digital signal processing devices (DSPD), programmable logic devices (PLDs), field programmable gate arrays (FPGA), controllers, micro-controllers, microprocessors, or other electronic components, for performing the above described methods.

In exemplary aspects of the present disclosure, there is also provided a non-transitory computer-readable storage medium including instructions, such as memory 504 including instructions, which is executed by the processor 518 in the apparatus 500, for performing the above-described methods. For example, the non-transitory computer-readable storage medium may be a ROM, a Radom Access Memory (RAM), a CD-ROM, a magnetic tape, a floppy disc, an optical data storage device, and the like.

In aspects of the present disclosure, the various modules (e.g., modules 310, 320, 330, 340, 410, 420, 430, 440, 450, 460), sub-modules (e.g., sub-modules 421, 422, 431, 432, 441 442), components (e.g., components 702, 706, 708, 710, 714, 716), and units may be implemented as processing circuitry that is configured to perform the various functions of the respective modules, sub-modules, components, and units.

Other aspects of the present disclosure will be apparent to those skilled in the art from consideration of the specification and practice of the present disclosure disclosed herein. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the precise structures that have been described above and/or illustrated in the accompanying drawings, and that various modifications and changes may be made without departing from the scope thereof. It is intended that the scope of the present disclosure only be limited by the appended claims.

What is claimed is:

1. A method for fingerprint recognition, the method comprising:
receiving a fingerprint recognition command from a user;
determining a region including positions of respective light sensors covered by at least one finger;
selecting a set of fingerprint recognition sensors from a plurality of fingerprint recognition sensors based on the region; and
acquiring, via the set of fingerprint recognition sensors, fingerprint data from the at least one finger.

2. The method according to claim 1, wherein determining the region includes:
measuring a plurality of brightness values via a plurality of light sensors;
determining a set of brightness values from the plurality of brightness values that are less than a preset threshold brightness value; and
determining a first region including a set of light sensors from the plurality of light sensors that measured the set of brightness values.

3. The method according to claim 2, further comprising:
determining whether the set of light sensors is covered by the at least one finger, and
wherein the set of fingerprint recognition sensors is selected based on the first region.

4. The method according to claim 1, wherein the plurality of fingerprint recognition sensors are distributed in an array on the liquid crystal display screen, wherein the array includes a plurality of columns and a plurality of rows, and wherein selecting the set of fingerprint recognition sensors includes:
determining a set of columns from the plurality of columns that are covered by the at least one finger and a set of rows from the plurality of rows that are covered by the at least one finger;
generating a rectangular recognition region by taking a number of columns in the set of columns as length and a number of rows in the set of rows as width; and
determining the set of fingerprint recognition sensors based on which of the plurality of fingerprint recognition sensors are distributed in the rectangular recognition region.

5. The method according to claim 1, wherein acquiring the fingerprint data includes:
connecting the set of fingerprint recognition sensors with corresponding data lines; and
receiving, via the data lines, the fingerprint data collected by the set of fingerprint recognition sensors.

6. The method according to claim 2, wherein acquiring the fingerprint data includes:
connecting the set of fingerprint recognition sensors with corresponding data lines: and
receiving, via the data lines, the fingerprint data collected by the set of fingerprint recognition sensors.

7. The method according to claim 3, wherein acquiring the fingerprint data includes:
connecting the set of fingerprint recognition sensors with corresponding data lines; and
receiving, via the data lines, fingerprint data collected by the set of fingerprint recognition sensors.

8. The method according to claim 4, wherein acquiring the fingerprint data includes:
connecting the set of fingerprint recognition sensors with corresponding data lines; and
receiving, via the data lines, fingerprint data collected by the part of fingerprint recognition sensors.

9. The method according to claim 5, wherein each of the plurality of the fingerprint recognition sensors is electrically connected with a corresponding one of a plurality of enabling lines, and wherein connecting the set of fingerprint recognition sensors with the corresponding data lines includes:
initializing the plurality of fingerprint recognition sensors; and
controlling corresponding ones of the enabling lines to connect the set of fingerprint recognition sensors with the corresponding data lines.

10. An apparatus for fingerprint recognition, the apparatus comprising:
a liquid crystal displays screen including a plurality of fingeiprint recognition sensors and a plurality of light sensors;
a processor; and
a memory for storing instructions executable by the processor, wherein the processor is configured to
receive a fingerprint recognition command from a user;
determine a region including positions of respective light sensors covered by at least one finger;
select a set of fingerprint recognition sensors from the plurality of fingerprint recognition sensors based on the region; and
acquire, via the set of fingerprint recognition sensors, fingerprint data from the at least one finger.

11. The apparatus according to claim 10, wherein the processor is further configured to:
measure a plurality of brightness values via the plurality of light sensors;
determine a set of brightness values from the plurality of brightness values that are less than a preset threshold brightness value; and
determine a first region including a set of light sensors from the plurality of light sensors that measured the set of brightness values.

12. The apparatus according to claim 11, wherein the processor is further configured to:
determine whether the set of light sensors is covered by the at least one finger, and
wherein the set of fingerprint recognition sensors is selected based on the first region.

13. The apparatus according to claim 10, wherein the plurality of fingerprint recognition sensors are distributed in an array on the liquid crystal display screen, wherein the array includes a plurality of columns and a plurality of rows, and wherein, when selecting the set of fingerprint recognition sensors, the processor is further configured to:
determine a set of columns from the plurality of columns that are covered by the at least one finger and a set of rows from the plurality of rows that are covered by the at least one finger;
generate a rectangular recognition region by taking a number of columns in the set of columns as length and a number of rows in the set of rows as width; and
determine the set of fingerprint recognition sensors based on which of the plurality of fingerprint recognition sensors are distributed in the rectangular recognition region.

14. The apparatus according to claim 10, wherein, when acquiring the fingerprint data the processor is further configured to
connect the set of fingerprint recognition sensors with corresponding data lines; and
receive, via the data lines, the fingerprint data collected by the set of fingerprint recognition sensors.

15. The apparatus according to claim ii, wherein, when acquiring the fingerprint data, the processor is further configured to:
connect the set of fingerprint recognition sensors with corresponding data lines; and
receive, via the data lines, the fingerprint data collected by the set of fingerprint recognition sensors.

16. The apparatus according to claim 12, wherein, when acquiring the fingerprint data, the processor is further configured to:
connect the set of fingerprint recognition sensors with corresponding data lines; and
receive, via the data lines, the fingerprint data collected by the set of fingerprint recognition sensors.

17. The apparatus according to claim 13, wherein, when acquiring the fingerprint data, the processor is further configured to:
connect the set of fingerprint recognition sensors with corresponding data lines; and
receive, via the data lines, the fingerprint data collected by the set of fingerprint recognition sensors.

18. The apparatus according to claim 11, wherein each of the plurality of the fingerprint recognition sensors is electrically connected with a corresponding one of a plurality of enabling lines, and wherein, when connecting the set of fingerprint recognition sensors with the corresponding data lines, the processor is further configured to:
initialize the plurality of fingerprint recognition sensors; and
control corresponding ones of the enabling lines to connect the set of fingerprint recognition sensors with the corresponding data lines.

19. A non-transitory computer-readable storage medium having stored therein instructions that, when executed by a processor, cause the processor to perform a method of fingerprint recognition, the method comprising:
receiving a fingerprint recognition command from a user;
determining a region including positions of respective light sensors covered by at least one finger:
selecting a set of fingerprint recognition sensors from a plurality of fingerprint recognition sensors based on the region; and
acquiring, via the set of fingerprint recognition sensors, fingerprint data from the at least one finger.
